(19) United States
(12) Patent Application Publication
(10) Pub. No.: US 2026/0003412 A1
(43) Pub. Date: Jan. 1, 2026

(54) POWER ADAPTER

(71) Applicant: Intel Corporation, Santa Clara, CA (US)

(72) Inventors: Bao SHAO, Shanghai (CN); Di ZHANG, Shanghai (CN); Weiwei WANG, Shanghai (CN); Binglin XU, Shenzhen (CN)

(21) Appl. No.: 19/329,197

(22) Filed: Sep. 15, 2025

(30) Foreign Application Priority Data
Aug. 26, 2025 (WO) PCTCN2025116885

(51) Int. Cl. G06F 1/26; G06F 1/28; G06F 1/30; H02J 7/00; H02J 7/34

(52) U.S. Cl. CPC G06F 1/263; G06F 1/28; G06F 1/30; H02J 7/0063; H02J 7/345; H02J 2207/20; H02J 2207/50

(57) ABSTRACT

The disclosure described herein generally relates to an apparatus, including: a Micro Controller Unit (MCU), configured to: monitor a working status of the apparatus; and communicate with an edge device when the edge device is connected with the apparatus; a Supercapacitor (SuperCAP) pack, configured to: discharge to supply power to the edge device when a power failure event occurs; and discharge to supply power to the edge device when a Central Processing Unit (CPU) of the edge device has a transient high peak current; a Buck-Boost voltage regulator controller, configured to drive a power stage MOSFET to regulate charging and discharging of the SuperCAP pack; and a power failure detection unit, configured to detect the power failure event.

### RELATED APPLICATION

This application claims the benefit of priority to Patent Cooperation Treaty (PCT) Application No. PCT/CN2025/116885, filed Aug. 26, 2025. The entire content of that application is incorporated by reference in its entirety.

### TECHNICAL FIELD

The disclosure described herein generally relates to a power adapter, integrating a Supercapacitor (SuperCAP) pack and a Micro Controller Unit (MCU) and, more particularly, to the use of a power adapter in supporting internal status monitoring in real time, abnormal events alert and timely communication with an edge device for power management.

### BACKGROUND

In scenarios where edge devices suffer sudden power outage or unknown power supply failure problems, solutions may be employed to provide power support. For example, adding a Li-ion battery or a SuperCAP based power module to a power adapter. However, the Li-ion battery is seldom adopted in edge devices because it's not fit for edge use condition. By contrast, SuperCAP based power module is a commonly used solution. For example, CN221929377U discloses a SuperCAP module which may be integrated into an edge device and requires main board or chassis change of the edge device. While some other modules may be outside of the edge device and requires cabling connections between the edge device and the SuperCAP module, adding more cabling interconnection for power delivery and data communication. These limitations and dependencies bring additional interface cost and add more design complexity. To address these issues, a power adapter is introduced to replace the traditional power adapter. The power adapter described herein ensures operation without board and system design dependency or external cabling added for interconnection.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram illustrating an example power adapter connected with an edge device.

FIG. 2 is a schematic diagram illustrating a structure of an example power adapter.

FIG. 3 is a flowchart illustrating an example process of an example power adapter according to an embodiment.

FIG. 4 is a flowchart illustrating another example process of an example power adapter according to an embodiment.

FIG. 5 is a flowchart illustrating yet another example process of an example power adapter according to an embodiment.

FIG. 6 is a flowchart illustrating another example process of an example power adapter according to an embodiment.

### DETAILED DESCRIPTION

Every day, there are millions of edge devices suffering unexpected power loss, resulting in critical data loss and hardware damage. For example, when an Industrial PC (IPC) is working on industrial control in a manufacturer, a sudden outage may cause a surprise power down to the IPC with critical data loss. In addition, millions of Artificial Intelligence Personal Computers (AI PCs) are facing unknown power-supply failure problems and running out of their battery power as a result of traditional power adapters' abnormality or damage, and thus inducing bad user experiences. Besides, performance of edge devices may be affected by limitation of peak power supply. For example, during AI workloads running, the system cannot achieve good performance as of Power Limit 4 (PL4) transient peak power limitation from power supply. The PL4 may refer to the highest transient peak power limitation defined in a power management protocol. It may represent the absolute maximum allowable instantaneous power level a component such as a Central Processing Unit (CPU) or System on Chip (SoC) may reach for extremely short durations. The PL4 transient peak power limitation refers to a mechanism for protecting the system by capping peak power against short-duration power spikes.

Regarding the above mentioned scenarios, Li-ion battery can be used to provide short time of power support during a power loss event. However, it cannot meet the requirements of a wide range of use conditions and thus is not safe in most edge scenarios, so battery is seldom adopted in edge devices.

To safeguard against events such as unexpected power-down events, a SuperCAP based power module may be adopted. The module is capable of providing power backup and data integrity. For example, in a solution where the SuperCAP based power module is integrated into an edge device for DC-IN voltage monitoring and providing backup power for a short time when unexpected power loss occurs. Such SuperCAP based power module depends on the mainboard's design and adds the system design complexity to the edge device. Despite being positioned outside the device, the SuperCAP based power module may still cause lots of inconveniences, such as creating more external cabling added for interconnection.

In contrast, in the power adapter described herein, no system hardware change is required. The power adapter may be easier to deploy and may create a possibility of user-enhanced experience for most modern devices including AIPC.

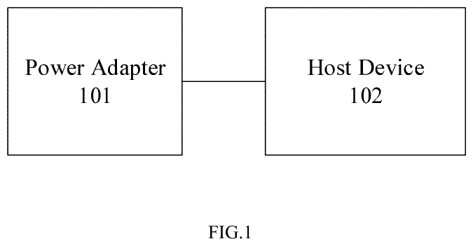

FIG. 1 is a schematic diagram illustrating an example power adapter connected with an edge device. As shown in FIG. 1, a power adapter 101 may be connected with a host device 102. In some examples, the electric connection between the power adapter 101 and the host device 102 may be established over an interface of the power adapter 101 and an interface of the host device 102. For example, each of the interfaces may be a standard Type-C interface which supports USB Power Delivery Specification Revision 3.0 (PD 3.0) protocol, USB Power Delivery Specification Revision 3.1 (PD 3.1) protocol and Universal Serial Bus 2.0 (USB 2.0) protocol, the interface may facilitate both power delivery and data communication between the host device 102 and the power adapter 101. The PD 3.0/3.1 Protocol refers to a power delivery standard for negotiating and supplying higher levels of electrical power over USB connections. It supports flexible voltage and current contracts up to 240 W. The USB 2.0 Protocol refers to a data communication standard for serial communication between devices with a maximum speed of 480 Mbps and minimal power provision.

The interface of the power adapter 101 and the interface of the host device 102 may be common interfaces for transmitting direct current. The interface of the power adapter 101 and the interface of the host device 102 may include any specific form as known in the field by those skilled in the art. The interfaces may be configured to enable data transmission between the power adapter 101 and the host device 102 when they are connected to each other.

In some examples, the host device 102 may include fixed and mobile modern devices that collect, process and transmit data at the network edge, for example, an edge device. The edge device may include but not limited to various metropolitan area network (MAN) and wide area network (WAN) access devices such as IPCs, multiplexers, routers, routing switches, Integrated Access Devices (IADs), Virtual Private Network (VPN) servers, AI PCs, Mini Personal Computers (Mini PCs).

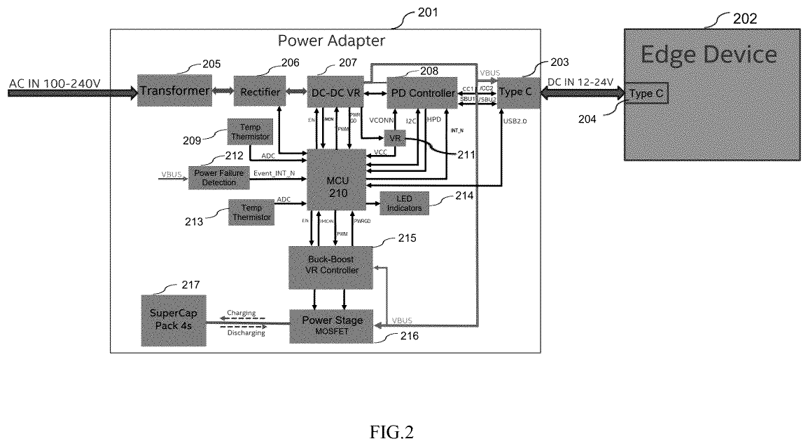

FIG. 2 is a schematic diagram illustrating a structure of an example power adapter. As shown in FIG. 2, a power adapter 201 is connected with an edge device 202. The power adapter 201 and the edge device 202 may be interconnected via interfaces such as USB Type-C interface. For example, the power adapter 201 may be equipped with a Type-C port 203. The edge device 202 may be equipped with a Type-C port 204. Interconnection between the power adapter 201 and the edge device 202 is not constrained by the physical medium. For instance, the interconnection may be achieved by plugging the power adapter 201 into the edge device 202. Alternatively, the interconnection may be achieved by a direct cable connection between the Type-C port 203 and the Type-C port 204. The connection may facilitate power delivery from the power adapter 201 to the edge device 202, operating at a direct current (DC) voltage, for example, ranging from 12 to 24 volts.

In some examples, the power adapter 201 may support a wide-ranging power input configuration. It may accommodate an alternating current (AC) supply, for example, operating at voltages between 100 and 240 volts. As shown in FIG. 2, the architecture of the power adapter 201 may be illustrated. The power adapter 201 may include a transformer 205, a rectifier 206, a DC-DC Voltage Regulator (VR) 207, a Power-Delivery (PD) controller 208, a Type-C port 203, a temp thermistor 209, an MCU 210, a VR 211, a power failure detection unit 212, a temp thermistor 213, LED indicators 214, a Buck-Boost VR controller 215, a power stage Metal Oxide Semiconductor Field Effect Transistor (MOSFET) 216, a SuperCAP Pack 217.

In some examples, the power adapter 201 receives power, such as Alternating Current (AC) power. For instance, the power adapter 201 may be powered by an AC main. The input voltage of the AC power may range from 100 to 240 volts. The input voltage may be applied to the transformer 205. The transformer 205 may be used for AC voltage step-down. For example, the transformer 205 may reduce a high voltage to a lower voltage. The lower voltage output from the transformer may be fed into the rectifier 206. The rectifier 206 may convert the alternating current into direct current. The DC output from the rectifier 206 may be inputted into the DC-DC VR 207. The DC-DC VR 207 may be used to provide efficient power conversion and to regulate the output to a precise and stable DC voltage level. The output from the DC-DC VR 207 may be employed as a VBUS power rail. The VBUS rail may serve as a DC voltage bus for the power adapter 201, distributing power to a plurality of ingredients of the power adapter 201. The ingredients may include, but not limited to, the PD controller 208, the power failure detection unit 212, the Type-C port 203, the Buck-Boost VR controller 215, the power stage MOSFET 216, the SuperCAP pack 217, etc.

A microcontroller unit (MCU) may be equipped with multiple General-Purpose Input/Output (GPIO) pins. The pins or interfaces of the MCU 210 described herein may represent only a subset of common functions, which should not be considered as a complete list of all available interfaces. The MCU 210 may offer digital control pins like Enable (EN) and Pulse-Width Modulation (PWM). It may provide status signals such as Power Good (PWRGD) and Current Monitor (IMON) and a signal for enable (EN signal), a signal for Pulse-Width Modulation (PWM signal). The MCU 210 may support interrupt and event pins such as Interrupt Active Low (INT_N) and Event Interrupt Active Low (EVENT_INT_N). It may also connect to other functions like Hot-Plug Detect (HPD). Communication may be done through an Inter-Integrated Circuit (I2C) or a USB 2.0. Additional interfaces like Hot-Plug Detect (HPD) and Analog-to-Digital Converter (ADC) inputs may also be available.

In some examples, the DC-DC VR 207 may transmit an IMON signal and a PWRGD signal to the MCU 210. The IMON signal may provide a real-time analog or digital representation of a load current. The PWRGD signal may be a digital flag that asserts when the DC-DC VR 207's output voltage is within its specified regulation limits. Conversely, the MCU 210 may exert control over the DC-DC VR 207 by issuing an EN signal through an EN pin and a PWM signal through a PWM pin. The EN signal may function as an on/off switch, allowing the MCU 210 to activate or shut down the DC-DC VR 207. The MCU 210 may command the DC-DC VR 207 via a PWM signal to, set, e.g. dynamically, the operating duty cycle of the DC-DC VR 207's switching converter. The DC-DC VR 207 may be connected to the VR 211.

In some examples, the temp thermistor 209 and the temp thermistor 213 may be connected with the MCU 210 via ADC inputs. The temp thermistors may refer to temperature-sensing thermistors. For example, the thermistor 209 may be a temperature-sensitive resistor whose electrical resistance changes significantly with temperature. The MCU 210 may measure the voltage across the temp thermistor 209 and convert the voltage to a digital value to calculate the temperature. When the temperature exceeds a predefined threshold, the thermistor 209's resistance shifts abruptly. The MCU 210 detects this change and may trigger protective actions, such as reducing power, activating cooling systems to prevent damage.

The connection between the temp thermistor 209 (or the temp thermistor 213) and the MCU 210 may enable the MCU 210 to measure and monitor the analog voltage signals from each sensor, converting them into digital temperature values. The MCU 210 may also be connected with the LED indicators 214. The LED indicators 214 may include one or more LED indicators, for example, configured to display the operation status of the MCU 210. The MCU 210 may be provided with an interface for connecting to the LED indicators 214 to transmit indication signals to them, or these LED indicators may receive signals from the MCU 210.

In some examples, the power failure detection unit 212 may be connected to the MCU 210 via an Event_INT_N (Event Interrupt, active-low) signal. For example, upon detecting a power failure event, the power failure detection unit 212 may assert Event_INT_N. The assertion may notify the MCU 210 of a power failure event occurrence. The VBUS may be connected to the power failure detection unit 212 for power supply.

In some examples, the power failure detection unit 212 may be configured to implement a power failure detection logic. The power failure detection unit 212 may be implemented as a hardware logic circuit. The power failure detection unit 212 may be configured to monitor the VBUS voltage in real-time. Once the voltage drops below the pre-defined threshold, it may trigger an Event_INT_N signal to the MCU 210 immediately, and MCU 210 may notify the edge device 202 of the power failure event immediately.

In some examples, the Buck-Boost VR controller 215 may communicate with the MCU 210 through signals, for example, an IMON signal, a PWRGD signal, an EN signal, a PWM signal. The IMON signal and the PWRGD signal are output from the Buck-Boost VR controller 215 to the MCU 210. The IMON signal may provide an analog or digital representation of the output current of the Buck-Boost VR controller 215. The PWRGD signal may be a digital flag that asserts when the Buck-Boost VR controller 215's output voltage is within its specified regulation limits. Conversely, the EN signal and the PWM signal are output from the MCU 210 to the Buck-Boost VR controller 215. The EN signal may be used to enable or disable the Buck-Boost VR controller 215. The PWM signal may serve as the primary control input from the MCU 210 to the Buck-Boost VR controller 215, modulating the switching duty cycle for precise voltage control.

The PD controller 208 may be equipped with multiple GPIO pins. The pins or interfaces of the PD controller 208 described herein may represent only a subset of common functions, which should not be considered a complete list of all available interfaces. The pins may include a Configuration Channel (CC) pin, a Sideband Use (SBU) pin, a Voltage Connector (VCONN) pin, etc. The PD controller 208 may support signals such as HPD and INT_N. The MCU 210 may communicate with the PD controller 208 via an INT_N signal. The PD controller 208 may notify the MCU 210 of information (e.g., connection status events) through an HPD output. The PD controller 208 may utilize the I2C communication interface to exchange data with the MCU 210. The PD controller 208 may include a VBUS pin for power supply path monitoring and control.

In some examples, the PD controller 208 may be connected with the DC-DC VR 207 though a GIPO pin. The DC-DC VR 207 may serve as the source of power to the PD controller 208. The PD controller 208 may be connected to the Type-C port 203 primarily through CC1/CC2 pins and SBU1/SBU2 pins. The VR 211 may be connected to the PD controller 208 though a VCONN pin. The VR 211 may also be connected with the MCU 210 though a VCC pin for power supply.

In some examples, the MCU 210 may be configured for management and communication. The MCU 210 may be the control center of the power adapter 201. The MCU 210 may be configured to monitor all the ingredients working in the power adapter 201, and to report any abnormal events to the edge device. The abnormal events may include voltage drop, high temperature, Over Voltage Protection (OVP), Over Current Protection (OCP), etc. The abnormal events may also refer to risk events, including over temperature event, voltage drop event, OVP event, OCP event, etc. It may be configured to control a power VR's working, for example, the DC-DC VR 207. It may also be configured to control the PD controller 208's settings and the SuperCAP Pack 217's charging and discharging. The MCU 210 may communicate with the edge device 202 via USB 2.0 protocol over Type-C interface. The MCU 210 may make the adapter more intelligent.

In some examples, the SuperCAP pack 217 may be a Supercapacitor pack. The Supercapacitors pack may include a plurality of Supercapacitors. The internal interconnection among these Supercapacitors may be implemented through various configurations. These configurations include, but are not limited to, simple parallel arrangements, series connections or hybrid topologies combining both series and parallel elements. As shown in FIG. 2, the SuperCAP pack 4s may be an example of the SuperCAP pack 217 including 4 Supercapacitor cells in series. The SuperCAP pack 217 may be configured to be charged to store power and discharged immediately as backup power once an unexpected power loss event occurs.

As shown in FIG. 2, the SuperCAP pack 217 is connected with the power stage MOSFET 216. In some examples, the SuperCAP pack 217 may be configured to work with a Buck-Boost VR circuit, and the Buck-Boost VR circuit may include the Buck-Boost VR controller 215. In some examples, the SuperCAP pack 217 may be configured to work with a Power VR circuit, and the Power VR circuit may include the Buck-Boost VR controller 215 and the power stage MOSFET 216. The Power VR circuit may be configured to support SuperCAP pack 217 charging and discharging. In some examples, the Buck-Boost VR controller 215 may drive the power stage MOSFET 216 to regulate both charging and discharging of the Supercapacitors in the SuperCAP pack 217. The SuperCAP pack 217 may work with the Buck-Boost VR circuit like a “micro-UPS” (“micro Uninterruptible Power Supply”) which may be charged to rated power capacity from a Voltage Bus (VBUS). Besides, the SuperCAP pack 217 may also provide inverting power to the VBUS immediately as a short-time backup power when power fails.

In some examples, the Type-C port 203 of the power adapter may be a standard Type-C which supports PD 3.0 protocol, PD 3.1 protocol and USB 2.0 protocol. The interface for example, the Type-C port 203 may facilitate both power delivery and data communication between the edge device 202 and the power adapter 201. The interconnections between the interfaces of the power adapter 201 and the edge device 202 may support timely communication with an edge device for power management. The Type-C port 203 and the MCU 210 may communicate using the USB 2.0 protocol.

The components and their corresponding reference numerals from the example in FIG. 2 will be referenced in the following example processes.

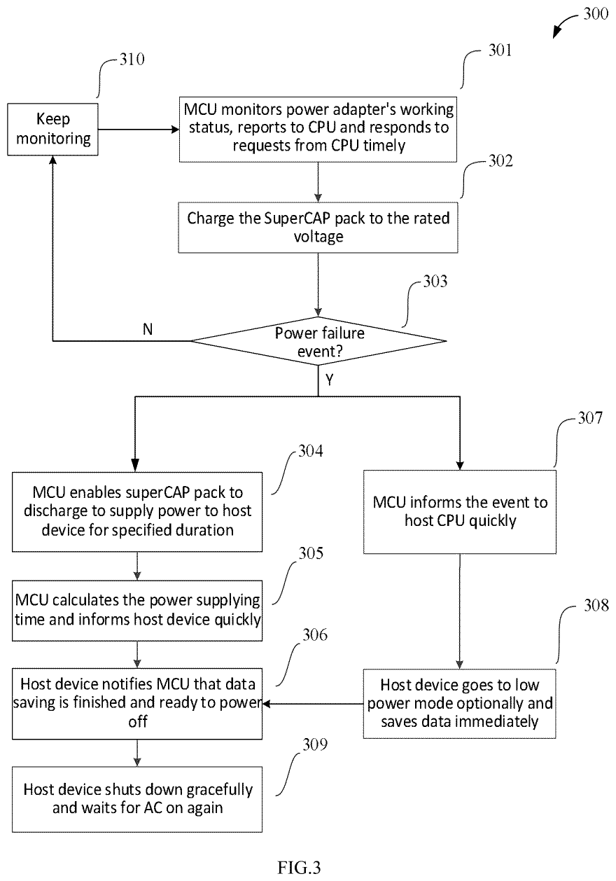

FIG. 3 is a flowchart illustrating an example process 300 of an example power adapter according to an embodiment. A power adapter (for example, the power adapter 201) may be connected with a host device (for example, the host device 102). The power adapter may be enabled to perform the process 300. The process 300 may include operations as shown in FIG. 3.

The process 300 may start when an MCU is enabled to work. The MCU may monitor the power adapter's working status, report to a CPU of the power adapter and respond to requests from the CPU timely 301. The SuperCAP pack may be charged to a rated voltage 302. The SuperCAP pack can be charged to store power. The MCU may control the SuperCAP pack's charging. A Buck-Boost VR circuit including the Buck-Boost VR controller and the power stage MOSFET may support the SuperCAP pack's charging. In the example power adapter, as shown in FIG. 2, the SuperCAP pack 217 may be configured to work with a Power VR circuit. The Power VR circuit (including the Buck-Boost VR controller 215 and the power stage MOSFET 216) may be configured to support the SuperCAP pack 217 charging and discharging. The SuperCAP pack 217 may be charged to rated power capacity from a VBUS and provide inverting power to the VBUS immediately as a short-time backup power when power fails.

The MCU may monitor whether there is a power failure event 303. The power failure detection unit may be used to detect power failure events. The MCU may monitor the power failure detection unit. If there is no power failure event, the MCU may keep monitoring 310, turning to the MCU monitoring the power adapter's working status, reporting to the CPU of the power adapter and responding to requests from the CPU timely 301. If a power failure event is detected by the power failure detection unit, the MCU may inform the event to a host CPU (the CPU of the host device) quickly 307. Then the host device may go to a low power mode optionally and save data immediately 308. For example, the MCU may inform the host device to operate in a low power mode and save data within the power supplying time. The host device may save data and protect itself when a power failure occurs. The host device may notify the MCU that the data saving is finished and ready to power off 306.

In some examples, the power failure detection unit may be configured to detect the power failure event. If a power failure event is detected by the power failure detection unit, the MCU may enable the SuperCAP pack to discharge to supply power to the host device for a specified duration 304. For example, the duration may last for more than 15 s. The MCU may calculate a power supplying time and inform the host device quickly 305. For example, the energy stored in the SuperCAP pack may support a certain discharge time. The power supplying time may be less than or equal to the certain discharge time. The power supplying time may define a maximum duration for which the host device can be powered. For example, a total energy that the SuperCAP pack may deliver to the host device can be calculated based on the following formula:

$$W = 0.5 \times C s c \times ( {U}^{2} - {UL}^{2} )$$

where W represents the total energy that the SuperCAP pack may deliver to the host device, Csc represents a total equivalent capacitance of the Supercapacitors of the SuperCAP pack, U represents the rated voltage of the SuperCAP pack, for example, the voltage across the Supercapacitors at the beginning of the discharging, and UL represents a minimum discharge voltage of the SuperCAP pack, for example, the lowest voltage at which the host device may function. For example, the host device may function in the low power mode or in other working modes.

The power supplying time may be calculated based on the following formula:

$$T = W / P$$

where T represents the power supplying time, W represents the total energy that the SuperCAP pack may deliver to the host device, and P represents the power consumption of the host device after the power failure.

Optionally, the host device may operate at a low voltage within the discharge time. The host device may save data and protect itself under the condition of power failure. The host device may notify the MCU that the data saving is finished and ready to power off 306. The host device may be ready to be shut down.

Following the host device's data saving finished and the host device being ready to power off 306, the host device may shut down gracefully and wait for power on again 309. The MCU may inform the host device to shut down after being informed that the edge device is ready to be shut down. For example, the power may include AC power input into the power adapter. For instance, the power adapter may be powered by an AC main, where the input voltage of the AC power may range from 100 to 240 volts.

In some examples, after the host device may shut down gracefully and wait for power on again 309, the process 300 may further include, when the power is on again, the power adapter may start AC-DC rectification and DC-DC voltage regulation then output power. The example power adapter, as shown in FIG. 2 may include a rectifier 206 for AC-DC rectification and a DC-DC Voltage Regulator (VR) 207 for DC-DC voltage regulation.

In some examples, the SuperCAP pack 217 may be configured to work with a Power VR circuit, and the Power VR circuit may include the Buck-Boost VR controller 215 and the power stage MOSFET 216. The Power VR circuit may be configured to support the SuperCAP pack 217 charging and discharging. In some examples, the Buck-Boost VR controller 215 may drive the power stage MOSFET 216 to regulate both charging and discharging of the Supercapacitors in the SuperCAP pack 217. The SuperCAP pack 217 may work with the Buck-Boost VR circuit like a “micro-UPS” which may be charged to rated power capacity from a Voltage Bus (VBUS). Besides, the SuperCAP pack 217 may also provide inverting power to the VBUS immediately as a short-time backup power when power fails.

In the process 300, the power adapter may support internal status monitoring in real time, abnormal events alert and timely communication with the host device for power management. The power adapter becomes an active intelligent device

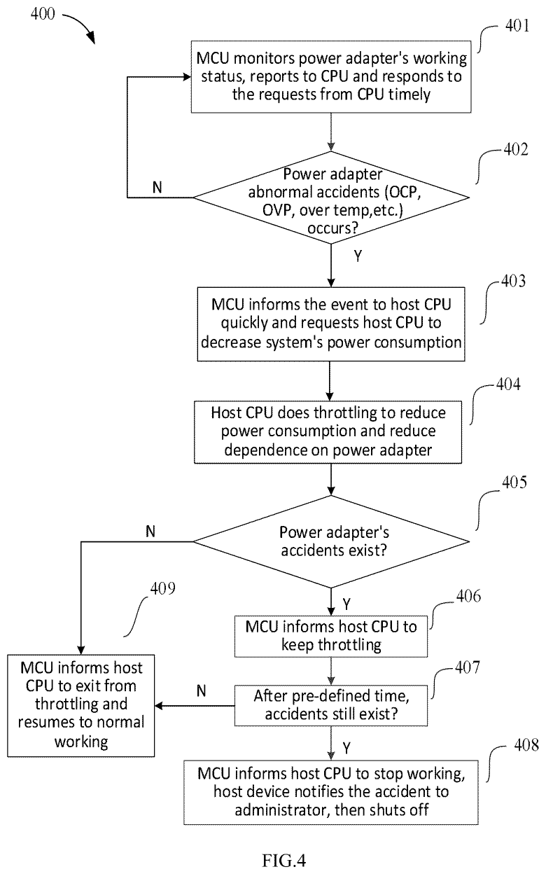

FIG. 4 is a flowchart illustrating another example process 400 of an example power adapter according to an embodiment. A power adapter (for example, the power adapter 201) may be connected with a host device (for example, the host device 102). The power adapter may be enabled to perform the process 400. The process 400 may include operations as shown in FIG. 4.

The process 400 may start when an MCU is enabled to work. The MCU may monitor the power adapter's working status, report to a CPU of the power adapter and respond to requests from the CPU timely 401. The MCU may monitor whether any power adapter abnormal accidents (OCP, OVP, over temp, etc.) occur 402. The power adapter abnormal accidents may include, for example, OCP events, OVP events, over temperature events. The abnormal accidents may occur in the power adapter. If there is no power adapter abnormal event, turn to the MCU monitoring the power adapter's working status, reporting to the CPU of the power adapter and responding to requests from the CPU timely 401.

If there is a power adapter abnormal event, the MCU may inform the event to the host CPU quickly and request the host CPU to decrease the system's power consumption 403. The system may include for example, a system or a program running on the host device. In the example power adapter, as shown in FIG. 2, under the condition of over temperature event, the thermistor's resistance may shift abruptly, and the MCU detects this change and may trigger protective actions, such as decreasing power consumption.

Following the MCU requesting the host CPU to decrease power consumption, the host CPU may perform throttling to reduce power consumption and reduce dependence on power adapter 404. For example, the MCU may request the CPU to perform throttling. The throttling may be a protective performance reduction mechanism of CPU. The throttling may include decreasing the CPU's operating frequency or voltage when excessive temperature, excessive power consumption, or excessive current exists. In some examples, if the host CPU may reduce dependence on power adapter, the event, for example, an over temperature event may end.

Then the MCU monitors whether the power adapter's accident exists 405. If the power adapter's accident doesn't exist, the MCU may inform the host CPU to exit from throttling and the host CPU may resume to normal working 409. The host CPU may exit from throttling. The host CPU may return to its normal working status. For example, the MCU may inform the CPU to exit from throttling when the event ends.

If the power adapter's accident exists, the MCU may inform the host CPU the CPU to keep throttling 406. For example, the MCU may inform the CPU to keep throttling if the event still exists after performing throttling once. The CPU may keep throttling until the event doesn't exist.

Following the CPU instructed to keep throttling, the MCU monitors, after a pre-defined time, whether the accident still exists 407. Then if the power adapter's accident doesn't exist, the MCU may inform the host CPU to exit from throttling and the host CPU may resume to normal working 409, and if the power adapter's accident still exists, the MCU may inform the host CPU to stop working, and the host device may notify the accident to an administrator (the administrator of the host device), then the host device may shut off 408. For example, the MCU may inform the CPU to stop working and to shut off if the risk event still exists after a pre-defined time.

In the process 400, the power adapter may support internal status monitoring in real time, abnormal events alert and timely communication with the host device for power management. The power adapter thereby becomes an active intelligent device.

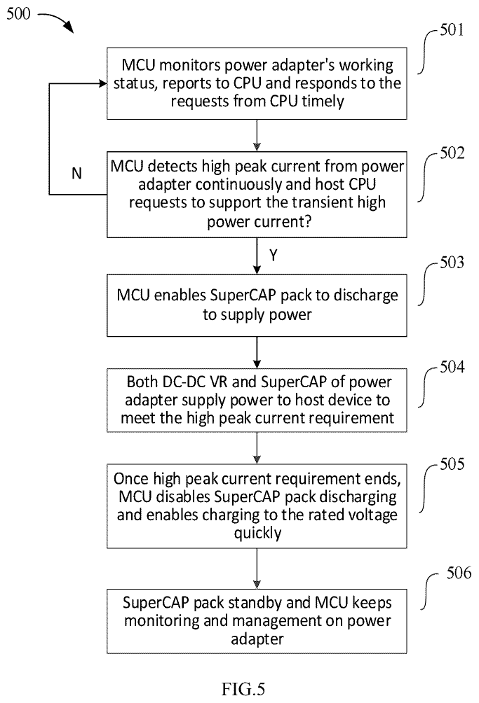

FIG. 5 is a flowchart illustrating another example process 500 of an example power adapter according to an embodiment. A power adapter (for example, the power adapter 201) may be connected with a host device (for example, the host device 102). The power adapter may be enabled to perform the process 500. The process 500 may include operations as shown in FIG. 5.

The process 500 may start when an MCU is enabled to work. The MCU may monitor the power adapter's working status, report to a CPU of the power adapter and respond to requests from the CPU timely 501. The MCU monitors whether there is a situation in which the MCU detects a high peak current from the power adapter continuously and the host CPU requests to support the transient high power current 502. For example, under scenarios such as turbo and other big power consuming workloads, the CPU may draw high peak current that rapidly flow through the power adapter continuously. If the situation doesn't exist, turn to the MCU monitoring the power adapter's working status, reporting to the CPU of the power adapter and responding to requests from the CPU timely 501. If the situation exists, the MCU may enable the SuperCAP pack to discharge to supply power 503. In response to the request from the host CPU to support the transient high power current, the SuperCAP pack of the power adapter may be discharged to supply power. For example, when the CPU of the edge device has a transient high peak current, the MCU may receive from the edge device information that the CPU has the transient high peak current, and may receive a request from the CPU for power support. Then the MCU may control the SuperCAP pack to discharge to supply power to the edge device.

In some examples, the high peak current, for example, a transient high peak current may exist in scenarios such as turbo workloads and other power-consuming workloads. Turbo workloads may refer to computationally intensive tasks that trigger the processor's turbo boost mechanism, demanding high instantaneous power and frequency. Other power-consumed workloads may include sustained operations, for example, data transcoding or parallel computations that consistently draw substantial electrical power.

Following the SuperCAP pack being enabled to discharge, the power adapter may supply power to the host device to meet the high peak current requirement. Both the DC-DC VR and the SuperCAP pack of the power adapter may supply power to the host device to meet the high peak current requirement 504. For example, the MCU may discharge the SuperCAP pack to supply power to the edge device and control the DC-DC voltage regulator to supply power to the edge device. Once the high peak current requirement ends, the MCU may disable the SuperCAP pack from discharging and may enable the SuperCAP pack to charge to the rated voltage quickly 505. For example, the SuperCAP pack may be disabled from discharging when a high peak current requirement for the transient high peak current is met. Both the SuperCAP pack and DC-DC voltage regulator supply power to the host device so as to support the CPU's PL4 power requirements by ensuring stable and sufficient current delivery. Thus, the high peak current requirement for the transient high peak current may be met. The energy that the SuperCAP pack possesses may decrease due to the discharge, so the SuperCAP pack may be charged to its rated voltage once the requirement is met. The SuperCAP pack may go on standby and MCU keeps monitoring and management on power adapter 506.

In the example power adapter, as shown in FIG. 2, the SuperCAP pack 217 may be configured to work with a Power VR circuit. The Power VR circuit (including the Buck-Boost VR controller 215 and the power stage MOSFET 216) may be configured to support SuperCAP pack 217 charging and discharging. The SuperCAP pack 217 may be charged to rated power capacity from a VBUS and provide inverting power to the VBUS immediately as a short-time backup power when power fails.

In the process 500, the power adapter may promptly support transient peak power supply for CPU PL4 requirements under turbo and big power consumed workloads scenarios.

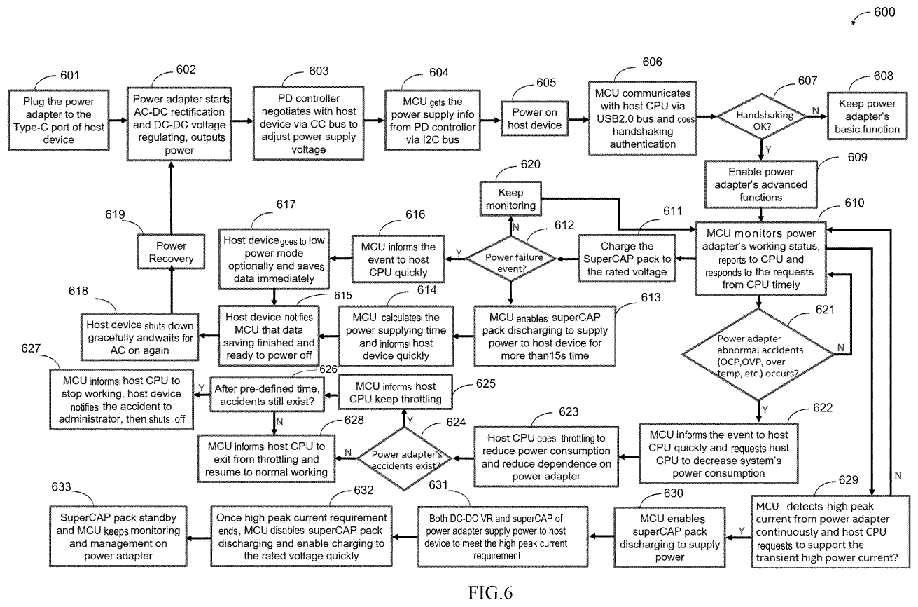

FIG. 6 is a flowchart illustrating another example process 600 of an example power adapter according to an embodiment. A power adapter (for example, the power adapter 201) may be connected with a host device (for example, the host device 102). The power adapter may be enabled to perform the process 600. The process 600 may include operations as shown in FIG. 6. The power adapter may be applied to a plurality of host devices, including most fixed and mobile modern devices (sizes of the devices may vary) with standard Type-C port, including AIPC. The power adapter may leverage with the industrial standard Type-C interface. Therefore, no change to the main board or chassis of the host device is required. Typical scenarios for the power adapter may include but not limited to the power-loss protection, the alert and protection for OCP, OVP, over-temp events, the transient peak power supply support for turbo and other power-consuming workloads etc.

The power adapter may provide MCU based management to the entire power adapter.

The process 600 may start when the power adapter is plugged to the Type-C port of host device 601. The power adapter and the host device may be connected, for example, by plugging the power adapter into the host device. The power adapter may be equipped with a Type-C port. The host device may be equipped with a Type-C port. The connection between the power adapter and the host device may also be achieved by a direct cable connection between the Type-C port and the Type-C port.

In some examples, the electrical input to the power adapter may be alternating current, with a voltage range typically between 100 and 240 volts. This range accommodates standard mains power specifications in many international regions.

Following plugging the power adapter to the Type-C port of the host device, the power adapter may start AC-DC rectification and DC-DC voltage regulating and output power 602. The example power adapter, as shown in FIG. 2 may include a transformer 205 for AC voltage step-down, a rectifier 206 for AC-DC rectification and a DC-DC Voltage Regulator (VR) 207 for DC-DC voltage regulation. The power is outputted from the DC-DC VR 207. The output power may be distributed via the VBUS. The VBUS may serve as a DC voltage bus for the power adapter. The VBUS may distribute power to the PD controller 208, the power failure detection unit 212, the Type-C port 203, the Buck-Boost VR controller 215 and the power stage MOSFET 216, etc.

Following the output power, the PD controller may negotiate with the host device via CC bus to adjust the power supply voltage 603. In the example power adapter shown in FIG. 2, the PD controller 208 may be connected to the Type-C port 203 primarily through CC1/CC2 pins and SBU1/SBU2 pins. The CC physical pins (CC1 and CC2) may form the foundation of the CC communication bus. The CC pins may establish the electrical pathway and protocol framework required for bidirectional communication between the PD controller 208 and the Type-C port 203. The CC pins may enable a plurality of functions such as power negotiation. The CC bus may refer to an integrated system of the CC pins, associated circuitry, and logical protocol operating over them.

Following adjusting the power supply voltage, the MCU may get the power supply info from the PD controller via I2C bus 604. Then the host device may be powered on 605. In the example power adapter shown in FIG. 2, the PD controller 208 may utilize the I2C communication interface to exchange data with the MCU 210. The I2C communication interface may be implemented through a physical pathway known as the I2C bus. The I2C bus may enable data exchange between the PD controller and the MCU.

Following the host device being powered on, the MCU may communicate with the host CPU via USB 2.0 bus and perform handshaking authentication 606. Then the MCU may determine whether the handshaking is OK 607. If the handshaking isn't OK, keep the power adapter's basic function 608. If the handshaking is OK, enable the power adapter's advanced functions 609. The advanced functions may include a plurality of possible operations, for example, the operations mentioned in the process 300, the process 400 and the process 500. Then these processes may start from the MCU monitoring the power adapter's working status, reporting to the CPU and responding to the requests from the CPU timely 610.

Following the MCU monitoring the power adapter's working status, reporting to the CPU and responding to the requests from the CPU timely 610, the process 600 may include multiple possible workflows. The workflows may include charging the SuperCAP pack to the rated voltage 611, determining whether any power adapter abnormal accidents (OCP, OVP, over temp, etc.) occurs 621, and whether there is a situation in which the MCU detects a high peak current from the power adapter continuously and the host CPU requests to support the transient high power current 629.

Following charging the SuperCAP pack to the rated voltage 611, the MCU may determine whether there is a power failure event 612. If there is no power failure event, the MCU may keep monitoring 620, then turning to the MCU monitoring the power adapter's working status, reporting to the CPU of the power adapter and responding to requests from the CPU timely 610.

If a power failure event is detected by the power failure detection unit, the MCU may inform the event to the host CPU (the CPU of the host device) quickly 616. Then the host device may go to a low power mode optionally and save data immediately 617. Therefore, the data integrity may be guaranteed. The host device may save data and protect itself when the power failure occurs. The host device may notify the MCU that the data saving is finished and ready to power off 615. In some examples, if a power failure event is detected by the power failure detection unit, the MCU may enable the SuperCAP pack to discharge to supply power to the host device for a specified duration 613. For example, the duration may last for more than 15 s. The duration is not limited herein and it may be specified in accordance with the practical requirements of the power adapter or the host device. Then the MCU calculates the power supply time and informs the host device quickly 614. With the power supply time provided by the MCU, the host device may save data and protect itself under the condition of power failure. Then the host device may notify the MCU that the data saving is finished and ready to power off 615.

Following the host device's data saving finished and the host device being ready to power off 615, the host device may shut down gracefully and wait for power on again 618. The power may include AC power input into the power adapter. Then turn to power recovery 619. When the power recovers 619, the power adapter may start AC-DC rectification and DC-DC voltage regulating and output power 602.

Turn to the workflow determining whether any power adapter abnormal accidents (OCP, OVP, over temp, etc.) occurs 621. If there is no power adapter abnormal event, turn to the MCU monitoring the power adapter's working status, reporting to the CPU of the power adapter and responding to requests from the CPU timely 610. If there is a power adapter abnormal event, the MCU may inform the event to the host CPU quickly and request the host CPU to decrease system's power consumption 622. Following the MCU requesting the host CPU to decrease power consumption, the host CPU may perform throttling to reduce power consumption and reduce dependence on power adapter 623.

Then the MCU monitors whether the power adapter's accident exists 624. If the power adapter's accident doesn't exist, the MCU may inform the host CPU to exit from throttling and the host CPU may resume to normal working 628. The host CPU may exit from throttling. The host CPU may return to its normal working status. The throttling may include decreasing the CPU's operating frequency or voltage when excessive temperature, excessive power consumption, or excessive current is detected. For example, if there is an over-temp accident, the thermistor's resistance may shift abruptly, and the MCU detects this change and may trigger protective actions, such as the throttling. The throttling may include decreasing the CPU's operating frequency. If the power adapter's accident exists, the MCU may inform the host CPU to keep throttling 625. Following the CPU instructed to keep throttling, the MCU monitors, after a pre-defined time, whether the accident still exists 626.

Then if the power adapter's accident doesn't exist, the MCU may inform the host CPU to exit from throttling and the host CPU may resume to normal working 628, and if the power adapter's accident still exists, the MCU may inform the host CPU to stop working, and the host device may notify the accident to the administrator (the administrator of the host device), then the host device may shut off 627. After the shut off, the host device may be powered on by the administrator in accordance with specific need.

Turn to the workflow whether there is a situation in which the MCU detects a high peak current from the power adapter continuously and the host CPU requests to support the transient high power current 629. If the situation doesn't exist, return to the MCU monitoring the power adapter's working status, reporting to the CPU and responding to the requests from the CPU timely 610. If the situation exists, the MCU may enable the SuperCAP pack to discharge to supply power 630. The SuperCAP pack of the power adapter may be discharged to supply power in response to the request from the host CPU to support the transient high power current. Both the DC-DC VR and the SuperCAP pack of the power adapter may supply power to the host device to meet the high peak current requirement 631.

Once the high peak current requirement ends, the MCU may disable the SuperCAP pack from discharging and may enable the SuperCAP pack to charge to the rated voltage quickly 632. After the high peak current requirement is met, the MCU may control the SuperCAP pack to stop discharging and to start charging to the rated voltage. The SuperCAP on standby may refer to a status where the SuperCAP pack maintains the rated voltage after being charged to the rated voltage. The SuperCAP pack may go on standby and MCU keeps monitoring and management on power adapter 633. In some examples, when the MCU keeps monitoring and management on the power adapter, the process may return to the MCU monitoring the power adapter's working status, reporting to the CPU of the power adapter and responding to requests from the CPU timely 610.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), System on-Chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a System on Chip (SoC) architecture.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

Each of the following non-limiting examples may stand on its own, or may be combined in various permutations or combinations with one or more of the other examples.
Example 1 is an apparatus, the apparatus including: a Micro Controller Unit (MCU), configured to: monitor a working status of the apparatus; and communicate with an edge device when the edge device is connected with the apparatus; a Supercapacitor (SuperCAP) pack, configured to: discharge to supply power to the edge device when a power failure event occurs; and discharge to supply power to the edge device when a Central Processing Unit (CPU) of the edge device has a transient high peak current; a Buck-Boost voltage regulator controller, configured to drive a power stage MOSFET to regulate charging and discharging of the SuperCAP pack; and a power failure detection unit, configured to detect the power failure event.
In Example 2, the subject matter of Example 1 includes wherein the MCU is further configured to: inform a risk event to the CPU when the risk event occurs, wherein the risk event includes at least one of an over voltage protection event, an over current protection event and an over temperature event; request the CPU to perform throttling; and inform the CPU to exit from throttling when the risk event ends.
In Example 3, the subject matter of Example 2 includes wherein the MCU is further configured to: inform the CPU to keep throttling if the risk event still exists after performing throttling once; and inform the CPU to stop working and to shut off if the risk event still exists after a pre-defined time.
In Example 4, the subject matter of Example 1 includes wherein the MCU is further configured to: calculate a power supplying time and inform the edge device of the power supplying time; and inform the edge device to shut down after being informed that the edge device is ready to be shut down.
In Example 5, the subject matter of Example 4 includes wherein the MCU is further configured, prior to being informed that the edge device is ready to be shut down, to: inform the edge device to operate in a low power mode and save data within the power supplying time; and receive from the edge device information that the edge device has saved data.
In Example 6, the subject matter of Example 1 further includes: a DC-DC voltage regulator, configured to supply power to the edge device when the CPU has the transient high peak current, and wherein the MCU is further configured to: receive from the edge device information that the CPU has the transient high peak current; receive a request from the CPU for power support; and discharge the SuperCAP pack to supply power to the edge device and control the DC-DC voltage regulator to supply power to the edge device.
In Example 7, the subject matter of Example 6 includes wherein the MCU is further configured to: disable the SuperCAP pack from discharging when a high peak current requirement for the transient high peak current is met; and charge the SuperCAP pack to a rated voltage.
Example 8 is at least one non-transitory machine-readable medium storing instructions which, when executed by at least one processor, cause the at least one processor to: connect a power adapter with an edge device via an interface; monitor a working status of the power adapter and communicate with the edge device; discharge a Supercapacitor (SuperCAP) pack of the power adapter to supply power to the edge device when a power failure event occurs; and discharge the SuperCAP pack to supply power to the edge device when a Central Processing Unit (CPU) of the edge device has a transient high peak current.
In Example 9, the subject matter of Example 8 includes wherein the instructions further cause the at least one processor to: inform a risk event to the CPU of when the risk event occurs, wherein the risk event includes at least one of an over voltage protection event, an over current protection event and an over temperature event; request the CPU to perform throttling; and inform the CPU to exit from throttling when the risk event ends.
In Example 10, the subject matter of Example 9 includes wherein the instructions further cause the at least one processor to: inform the CPU to keep throttling if the risk event still exists after performing throttling once; and inform the CPU to stop working and to shut off if the risk event still exists after a pre-defined time.
In Example 11, the subject matter of Example 8 includes wherein the instructions further cause the at least one processor to: calculate a power supplying time and inform the edge device of the power supplying time; and shut down the edge device after the edge device informs the MCU that the edge device is ready to be shut down.
In Example 12, the subject matter of Example 11 includes wherein the instructions further cause the at least one processor, prior to the edge device being ready to be shut down, to: operate in a low power mode and save data within the power supplying time; and inform the MCU that the edge device has saved data.
In Example 13, the subject matter of Example 8 includes wherein the power adapter includes a DC-DC voltage regulator, and wherein the instructions further cause the at least one processor to: inform the MCU of the transient high peak current when the CPU has the transient high peak current; request, by the CPU, power support; and discharge the SuperCAP pack and control the DC-DC voltage regulator to supply power to the edge device.
In Example 14, the subject matter of Example 13 includes wherein the instructions further cause the at least one processor to: disable the SuperCAP pack from discharging when a high peak current requirement for the transient high peak current is met; and charge the SuperCAP pack to a rated voltage.
Example 15 is a system, the system including: an edge device; a power adapter, wherein the power adapter includes: a Micro Controller Unit (MCU), configured to: monitor a working status of the power adapter; and communicate with the edge device; a Supercapacitor (SuperCAP) pack, configured to: discharge to supply power to the edge device when a power failure event occurs; and discharge to supply power to the edge device when a Central Processing Unit (CPU) of the edge device has a transient high peak current; a Buck-Boost voltage regulator controller, configured to: drive a power stage MOSFET to regulate charging and discharging of the SuperCAP pack; and a power failure detection unit, configured to detect the power failure event; and an interface, configured to provide power delivery and data communication between the power adapter and the edge device.
In Example 16, the subject matter of Example 15 includes wherein the MCU is further configured to: inform a risk event to the CPU when the risk event occurs, wherein the risk event includes at least one of an over voltage protection event, an over current protection event and an over temperature event; request the CPU to perform throttling; and inform the CPU to exit from throttling when the risk event ends.
In Example 17, the subject matter of Example 15 includes wherein the interface includes a Type-C standard interface.
In Example 18, the subject matter of Example 16 includes wherein the MCU is further configured to: inform the CPU to keep throttling if the risk event still exists after performing throttling once; and inform the CPU to stop working and to shut off if the risk event still exists after a pre-defined time.
In Example 19, the subject matter of Example 15 includes wherein the MCU is further configured to: calculate a power supplying time and inform the edge device of the power supplying time; and inform the edge device to shut down after being informed that the edge device is ready to be shut down.
In Example 20, the subject matter of Example 19 includes wherein the MCU is further configured, prior to being informed that the edge device is ready to be shut down, to: inform the edge device to operate in a low power mode and save data within the power supplying time; and receive from the edge device information that the edge device has saved the data.
In Example 21, the subject matter of Example 15 further includes: a DC-DC voltage regulator, configured to supply power to the edge device when the CPU has the transient high peak current, and wherein the MCU is further configured to: receive from the edge device information that the CPU has the transient high peak current; receive a request from the CPU for power support; and discharge the SuperCAP pack to supply power to the edge device and control the DC-DC voltage regulator to supply power to the edge device.
In Example 22, the subject matter of Example 21 includes wherein the MCU is further configured to: disable the SuperCAP pack from discharging if a high peak current requirement for the transient high peak current is met; and charge the SuperCAP pack to a rated voltage.
Example 23 is an apparatus for power management, including: means for connecting a power adapter with an edge device via an interface; means for monitoring a working status of the power adapter and communicating with the edge device; means for discharging a Supercapacitor (SuperCAP) pack of the power adapter to supply power to the edge device when a power failure event occurs; and means for discharging the SuperCAP pack to supply power to the edge device when a Central Processing Unit (CPU) of the edge device has a transient high peak current.
In Example 24, the subject matter of Example 23 includes: means for informing a risk event to the CPU of when the risk event occurs, wherein the risk event includes at least one of an over voltage protection event, an over current protection event and an over temperature event; means for requesting the CPU to perform throttling; and means for informing the CPU to exit from throttling when the risk event ends.
In Example 25, the subject matter of Example 24 includes: means for informing the CPU to keep throttling if the risk event still exists after performing throttling once; and means for informing the CPU to stop working and to shut off if the risk event still exists after a pre-defined time.
In Example 26, the subject matter of Example 23 includes: means for calculating a power supplying time and informing the edge device of the power supplying time; and means for shutting down the edge device after the edge device informs the MCU that the edge device is ready to be shut down.
In Example 27, the subject matter of Example 26 includes: means for operating in a low power mode and saving data within the power supplying time; and means for informing the MCU that the edge device has saved the data.
In Example 28, the subject matter of Example 23 includes wherein the power adapter includes a DC-DC voltage regulator, and wherein the subject matter of Example 23 further includes: means for informing the MCU of the transient high peak current when the CPU has the transient high peak current; means for requesting, by the CPU, power support; and means for discharging the SuperCAP pack and controlling the DC-DC voltage regulator to supply power to the edge device.
In Example 29, the subject matter of Example 28 includes: means for disabling the SuperCAP pack from discharging if a high peak current requirement for the transient high peak current is met; and means for charging the SuperCAP pack to a rated voltage.
Example 30 is a method, including: connecting a power adapter with an edge device via an interface; monitoring a working status of the power adapter and communicating with the edge device; discharging a Supercapacitor (SuperCAP) pack of the power adapter to supply power to the edge device when a power failure event occurs; and discharging the SuperCAP pack to supply power to the edge device when a Central Processing Unit (CPU) of the edge device has a transient high peak current.
In Example 31, the subject matter of Example 30 further includes: informing a risk event to the CPU of when the risk event occurs, wherein the risk event includes at least one of an over voltage protection event, an over current protection event and an over temperature event; requesting the CPU to perform throttling; and informing the CPU to exit from throttling when the risk event ends.
In Example 32, the subject matter of Example 30 or 31 further includes: informing the CPU to keep throttling if the risk event still exists after performing throttling once; and informing the CPU to stop working and to shut off if the risk event still exists after a pre-defined time.
In Example 33, the subject matter of Examples 30 to 32 further includes: calculating a power supplying time and informing the edge device of the power supplying time; and shutting down the edge device after the edge device informs the MCU that the edge device is ready to be shut down.
In Example 34, the subject matter of Examples 30 to 33 further includes: operating in a low power mode and saving data within the power supplying time; and informing the MCU that the edge device has saved the data.
In Example 35, the subject matter of Examples 30 to 34 further includes: wherein the power adapter includes a DC-DC voltage regulator, and wherein the subject matter of Examples 30 to 34 further includes: informing the MCU of the transient high peak current when the CPU has the transient high peak current; requesting, by the CPU, power support; and discharging the SuperCAP pack and controlling the DC-DC voltage regulator to supply power to the edge device.
In Example 36, the subject matter of Examples 30 to 35 further includes: disabling the SuperCAP pack from discharging if a high peak current requirement for the transient high peak current is met; and charging the SuperCAP pack to a rated voltage.
Example 37 is one or more computer-readable media storing instructions which, when executed by one or more processors, cause the one or more processors to perform the subject matter of any one of Examples 30 to 36.
Example 38 is a computing apparatus including means for performing the subject matter of any one of Examples 30 to 36.
Example 39 is a computer program product including instructions which, when executed by one or more processors, cause the one or more processors to perform the subject matter of any one of Examples 30 to 36.
Example 40 is a computer program including instructions which, when executed by one or more processors, cause the one or more processors to perform the subject matter of any one of Examples 30 to 36.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An apparatus, comprising:
a Micro Controller Unit (MCU), configured to:
monitor a working status of the apparatus; and
communicate with an edge device when the edge device is connected with the apparatus;
a Supercapacitor (SuperCAP) pack, configured to:
discharge to supply power to the edge device when a power failure event occurs; and
discharge to supply power to the edge device when a Central Processing Unit (CPU) of the edge device has a transient high peak current;
a Buck-Boost voltage regulator controller, configured to:
drive a power stage Metal Oxide Semiconductor Field Effect Transistor (MOSFET) to regulate charging and discharging of the SuperCAP pack; and
a power failure detection unit, configured to detect the power failure event.

2. The apparatus of claim 1, wherein the MCU is further configured to:
indicate a risk event to the CPU when the risk event occurs, wherein the risk event comprises at least one of an over voltage protection event, an over current protection event and an over temperature event;
request the CPU to perform throttling; and
inform the CPU to exit from the throttling when the risk event ends.

3. The apparatus of claim 2, wherein the MCU is further configured to:
inform the CPU to keep throttling if the risk event exists after performing throttling once; and
inform the CPU to shut off if the risk event still exists after a pre-defined time.

4. The apparatus of claim 1, wherein the MCU is further configured to:
calculate a power supplying time and inform the edge device of the power supplying time; and
inform the edge device to shut down after being informed that the edge device is ready to be shut down.

5. The apparatus of claim 4, wherein the MCU is further configured, prior to being informed that the edge device is ready to be shut down, to:
inform the edge device to operate in a low power mode and save data within the power supplying time; and
receive from the edge device information that the edge device has saved the data.

6. The apparatus of claim 1, wherein the apparatus further comprises:
a direct current (DC)-DC voltage regulator, configured to supply power to the edge device when the CPU has the transient high peak current, and wherein the MCU is further configured to:
receive from the edge device information that the CPU has the transient high peak current;
receive a request from the CPU for power support; and
discharge the SuperCAP pack to supply power to the edge device and control the DC-DC voltage regulator to supply power to the edge device.

7. The apparatus of claim 6, wherein the MCU is further configured to:
disable the SuperCAP pack from discharging if a high peak current requirement for the transient high peak current is met; and
charge the SuperCAP pack to a rated voltage.

8. At least one non-transitory machine-readable medium storing instructions which, when executed by at least one processor, cause the at least one processor to:
connect a power adapter with an edge device via an interface;
monitor a working status of the power adapter and communicate with the edge device;
discharge a Supercapacitor (SuperCAP) pack of the power adapter to supply power to the edge device when a power failure event occurs; and
discharge the SuperCAP pack to supply power to the edge device when a Central Processing Unit (CPU) of the edge device has a transient high peak current.

9. The non-transitory machine-readable medium of claim 8, wherein the instructions further cause the at least one processor to:
inform a risk event to the CPU of when the risk event occurs, wherein the risk event comprises at least one of an over voltage protection event, an over current protection event and an over temperature event;
request the CPU to perform throttling; and
inform the CPU to exit from throttling when the risk event ends.

10. The non-transitory machine-readable medium of claim 9, wherein the instructions further cause the at least one processor to:
inform the CPU to keep throttling if the risk event still exists after performing throttling once; and
inform the CPU to stop working and to shut off if the risk event exists after a pre-defined time.

11. The non-transitory machine-readable medium of claim 8, wherein the instructions further cause the at least one processor to:
calculate a power supplying time and inform the edge device of the power supplying time; and
shut down the edge device after the edge device informs an Micro Controller Unit (MCU) that the edge device is ready to be shut down.

12. The non-transitory machine-readable medium of claim 11, wherein the instructions further cause the at least one processor, prior to the edge device being ready to be shut down, to:
operate in a low power mode and save data within the power supplying time; and
inform the MCU that the edge device has saved the data.

13. The non-transitory machine-readable medium of claim 8, wherein the power adapter comprises a DC-DC voltage regulator, and wherein the instructions further cause the at least one processor to:
inform an Micro Controller Unit (MCU) of the transient high peak current when the CPU has the transient high peak current;
request, by the CPU, power support; and
discharge the SuperCAP pack and control the DC-DC voltage regulator to supply power to the edge device.

14. The non-transitory machine-readable medium of claim 13, wherein the instructions further cause the at least one processor to:
disable the SuperCAP pack from discharging if a high peak current requirement for the transient high peak current is met; and
charge the SuperCAP pack to a rated voltage.

15. A system, comprising:
an edge device;
a power adapter, wherein the power adapter comprises:
a Micro Controller Unit (MCU), configured to:
monitor a working status of the power adapter; and
communicate with the edge device;
a Supercapacitor (SuperCAP) pack, configured to:
discharge to supply power to the edge device when a power failure event occurs; and
discharge to supply power to the edge device when a Central Processing Unit (CPU) of the edge device has a transient high peak current;
a Buck-Boost voltage regulator controller, configured to:
drive a power stage Metal Oxide Semiconductor Field Effect Transistor (MOSFET) to regulate charging and discharging of the SuperCAP pack; and
a power failure detection unit, configured to detect the power failure event; and
an interface, configured to provide power delivery and data communication between the power adapter and the edge device.

16. The system of claim 15, wherein the MCU is further configured to:
inform a risk event to the CPU when the risk event occurs, wherein the risk event comprises at least one of an over voltage protection event, an over current protection event and an over temperature event;
request the CPU to perform throttling; and
inform the CPU to exit from throttling when the risk event ends.

17. The system of claim 15, wherein the interface includes a Type-C standard interface.

18. An apparatus for power management, comprising:
means for connecting a power adapter with an edge device via an interface;
means for monitoring a working status of the power adapter and communicate with the edge device;
means for discharging a Supercapacitor (SuperCAP) pack of the power adapter to supply power to the edge device when a power failure event occurs; and
means for discharging the SuperCAP pack to supply power to the edge device when a Central Processing Unit (CPU) of the edge device has a transient high peak current.

19. The apparatus of claim 18, further comprising:
means for informing a risk event to the CPU of when the risk event occurs, wherein the risk event comprises at least one of an over voltage protection event, an over current protection event and an over temperature event;
means for requesting the CPU to perform throttling; and
means for informing the CPU to exit from throttling when the risk event ends.

20. The apparatus of claim 19, further comprising:
means for informing the CPU to keep throttling if the risk event still exists after performing throttling once; and
means for informing the CPU to stop working and to shut off if the risk event still exists after a pre-defined time.
